(19) United States
(12) Patent Application Publication
(10) Pub. No.: US 2007/0109238 A1
(43) Pub. Date: May 17, 2007

(54) LIQUID CRYSTAL DISPLAY AND METHOD THEREOF

(75) Inventors: Back-Won LEE, Cheonan-si (KR); Seong-Young LEE, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD.,, Suwon-si (KR)

(21) Appl. No.: 11/555,832

(22) Filed: Nov. 2, 2006

(30) Foreign Application Priority Data
Nov. 14, 2005 (KR) 1020050108427

(51) Int. Cl. G09G 3/36

(52) U.S. Cl. 345/87

(57) ABSTRACT

The liquid crystal display includes a substrate, and pixel electrodes are formed on the substrate, each of which has first and second subpixel electrodes. Each of the first and second subpixel electrodes has at least two parallelogrammic electrode pieces, each of which has lengthwise edges and oblique edges adjacent to the lengthwise edges.

This application claims priority to Korean Patent Application No. 10-2005-0108427, filed on Nov. 14, 2005 and all the benefits accruing therefrom under 35 U.S.C. §119, and the contents of which in its entirety are herein incorporated by reference.

### BACKGROUND OF THE INVENTION

(a) Field of the Invention

The present invention relates to a liquid crystal display (“LCD”) and method thereof. More particularly, the present invention relates to an LCD having improved lateral visibility and a method of improving lateral visibility in the LCD.

(b) Description of the Related Art

Generally, liquid crystal displays (“LCDs”) have been widely used as an example of a flat display device. The LCD includes two display panels on which field generating electrodes, such as pixel electrodes and a common electrode, are formed, and a liquid crystal layer interposed between the two display panels. In the LCD, an electric field is generated in the liquid crystal layer by applying a voltage to the field generating electrodes so as to determine alignment of liquid crystal molecules in the liquid crystal layer, and images are displayed by controlling polarization of incident light.

The LCD further includes switching elements that are respectively connected to the pixel electrodes, and a plurality of signal lines, such as gate lines, data lines, and the like, that control the switching elements to allow a voltage to be applied to the pixel electrodes.

An LCD of a vertically aligned (“VA”) mode has a large contrast ratio and a wide reference viewing angle, in which long axes of liquid crystal molecules are perpendicular to the upper and lower display panels in a state in which an electric field is not applied. In this case, the reference viewing angle refers to a viewing angle at which a contrast ratio is 1:10, or a luminance inversion limit angle between grays.

As a method of achieving a wide viewing angle in an LCD of a VA mode, there are a method of forming a cutout in a field generating electrode, and a method of forming a protrusion above or below the field generating electrode. Since the cutouts and the protrusions determine a tilt direction of liquid crystal molecules, the tilt direction of liquid crystal molecules is decentralized by appropriately disposing the cutouts and the protrusions, thereby widening a reference viewing angle.

As a method of improving lateral visibility, the following method has been suggested. One pixel is divided into two subpixels, and the divided two subpixels are capacitively coupled with each other. Then, a voltage is directly applied to one subpixel, and a voltage drop through the capacitive coupling is generated in the other subpixel, such that voltages between the two subpixels are different from each other, which causes transmittance to be different in the two subpixels.

### BRIEF SUMMARY OF THE INVENTION

Exemplary embodiments of the present invention provide a liquid crystal display (“LCD”) including a substrate, and pixel electrodes formed on the substrate, each of the pixel electrodes having first and second subpixel electrodes. Each of the first and second subpixel electrodes has at least two parallelogrammic electrode pieces, each of the two parallelogrammic electrode pieces having lengthwise edges and oblique edges adjacent to the lengthwise edges.

In each of the first and second subpixel electrodes, the lengthwise edges of the at least two electrode pieces may contact each other. In each of the first and second subpixel electrodes, the oblique edges of the at least two electrode pieces may form a right angle so as to be connected to each other.

A height of the first subpixel electrode may be different from a height of the second subpixel electrode.

The first subpixel electrode and the second subpixel electrode may be adjacent to each other in a vertical direction. A lengthwise center line of the first subpixel electrode may be aligned with a lengthwise center line of the second subpixel electrode.

The LCD according to the exemplary embodiment of the present invention may further include a common electrode that faces the pixel electrodes, and first inclination direction determining members that are formed on the common electrode.

The first inclination direction determining members may include a plurality of first cutouts that have oblique portions substantially parallel to the oblique edges of the electrode pieces.

The LCD according to the exemplary embodiment of the present invention may further include second inclination direction determining members, each of which is formed in each of the first and second subpixel electrodes.

The second inclination direction determining members may have a plurality of second cutouts that have oblique portions substantially parallel to the oblique edges of the electrode pieces.

A voltage of the first subpixel electrode and a voltage of the second subpixel electrode may be different from each other.

An area of the first subpixel electrode may be smaller than an area of the second subpixel electrode, and the voltage of the first subpixel electrode may be larger than the voltage of the second subpixel electrode.

The first subpixel electrode and the second subpixel electrode may be applied with different data voltages obtained from image information.

The LCD according to the exemplary embodiments of the present invention may further include first thin film transistors (“TFTs”) connected to corresponding first subpixel electrodes, second TFTs connected to corresponding second subpixel electrodes, first signal lines connected to the first TFTs, second signal lines connected to the second TFTs, and third signal lines connected to the first and second TFTs and crossing the first and second signal lines.

The first and second TFTs may be turned on according to signals supplied through the first and second signal lines, and may transmit signals supplied through the third signal lines.

Alternatively, the first and second TFTs may be turned on according to signals supplied through the third signal lines, and may transmit signals supplied through the first and the second signal lines.

The LCD according to the exemplary embodiments of the present invention may further include fourth signal lines crossing the pixel electrodes. The first and second TFTs may have first and second drain electrodes overlapping the fourth signal lines.

The first subpixel electrode and the second subpixel electrode may be capacitively coupled with each other.

The LCD according to other exemplary embodiments of the present invention may include TFTs connected to corresponding first subpixel electrodes, first signal lines connected to corresponding TFTs, and second signal lines connected to the TFTs and crossing the first signal lines.

The first and second subpixel electrodes may be connected to each other.

Other exemplary embodiments of the present invention provide an LCD including a substrate, and pixel electrodes formed on the substrate. Each of the pixel electrodes has at least two parallelogrammic electrode pieces, and each of the parallelogrammic electrode pieces has lengthwise edges and oblique edges adjacent to the lengthwise edges.

The lengthwise edges of the at least two electrode pieces may come into contact with each other. The oblique edges of the at least two electrode pieces may form a right angle so as to be connected to each other.

The LCD according to other exemplary embodiments of the present invention may further include TFTs connected to the pixel electrodes, first signal lines connected to the TFTs, and second signal lines connected to the TFTs and crossing the first signal lines.

In the above-described embodiments, each of the first and second subpixel electrodes may have a substantially simple concave hexagon shape formed in an arrow shape with one concavity. A convex portion of the first subpixel electrodes may be nested within the concavity of adjacent second subpixel electrodes, and a convex portion of the second subpixel electrodes may be nested within the concavity of adjacent first subpixel electrodes.

Other exemplary embodiments of the present invention provide a method of improving lateral visibility in a liquid crystal display, the method including forming gate lines in a first direction on a substrate, forming data lines in a second direction on the substrate, and forming at least one pixel electrode per pixel area on the substrate, the at least one pixel electrode having a substantially simple concave hexagon shape formed in an arrow shape with one concavity, the arrow shape pointing in the second direction.

Forming the at least one pixel electrode per pixel area may include forming first and second subpixel electrodes per pixel area, each of the first and second subpixel electrodes having a substantially simple concave hexagon shape formed in an arrow shape with one concavity, the arrow shape pointing in the second direction, the second subpixel electrodes nesting within concavities of adjacent first pixel electrodes, and the first subpixel electrodes nesting within concavities of adjacent second subpixel electrodes.

Forming the at least one pixel electrode per pixel area may also include forming first and second subpixel electrodes per pixel area and forming an area of the first subpixel electrodes smaller than an area of the second subpixel electrodes, and the method may further include applying a larger voltage via the data lines to the first subpixel electrodes than to the second subpixel electrodes.

### BRIEF DESCRIPTION OF THE DRAWINGS

The present invention will become more apparent by further describing exemplary embodiments thereof with reference to the accompanying drawings, in which:

FIG. 1 is a block diagram illustrating an exemplary liquid crystal display (“LCD”) device according to an exemplary embodiment of the present invention;

FIG. 2 is an equivalent circuit diagram of two exemplary subpixels in an exemplary LCD according to an exemplary embodiment of the present invention;

FIG. 3 is an equivalent circuit diagram of one exemplary subpixel in an exemplary LCD according to an exemplary embodiment of the present invention;

FIGS. 4A and 4B are views illustrating an exemplary pixel electrode in an exemplary LCD according to an exemplary embodiment of the present invention;

FIG. 5 is a layout view of an exemplary LCD according to an exemplary embodiment of the present invention;

FIGS. 6 and 7 are cross-sectional views taken along lines VI-VI and VII-VII in the exemplary LCD shown in FIG. 5;

FIG. 8 is an equivalent circuit diagram of an exemplary pixel in an exemplary LCD according to another exemplary embodiment of the present invention;

FIG. 9 is a layout view of an exemplary LCD according to another exemplary embodiment of the present invention;

FIG. 10 is an equivalent circuit diagram of an exemplary pixel in an exemplary LCD according to another exemplary embodiment of the present invention;

FIG. 11 is a layout view of an exemplary LCD according to another exemplary embodiment of the present invention;

FIG. 12 is an equivalent circuit diagram of an exemplary pixel in an exemplary LCD according to another exemplary embodiment of the present invention; and,

FIG. 13 is a layout view of an exemplary LCD according to another exemplary embodiment of the present invention.

### DETAILED DESCRIPTION OF THE INVENTION

The present invention will be described more fully hereinafter with reference to the accompanying drawings, in which preferred embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Since it is difficult for light to be transmitted at portions where protrusions or cutouts are formed, when the number of protrusions and cutouts is increased, the aperture ratio is decreased. In order to increase the aperture ratio, a structure has been suggested for increasing the size of each pixel electrode. However, in this case, since the distance between pixel electrodes and the distance between a pixel electrode and a data line are short, a strong lateral field is generated at a pixel electrode edge. Alignment of the liquid crystal molecules is scattered due to the lateral field. As a result, texture or light leakage occurs, and the response time is increased.

Further, liquid crystal displays (“LCDs”) of a vertically aligned (“VA”) mode have poor lateral visibility as compared with front visibility. For example, in an LCD of a patterned vertically aligned (“PVA”) mode, images gradually become brighter in a lateral direction. In the worst case, the luminance difference between high grays does not exist, and thus pictures may be viewed in a state in which they are broken.

Thus, the present invention provides an LCD having advantages of improving lateral visibility.

Further, the present invention provides an LCD having advantages of forming pixels with a simple structure.

Hereinafter, the present invention will be described in detail with reference to the accompanying drawings.

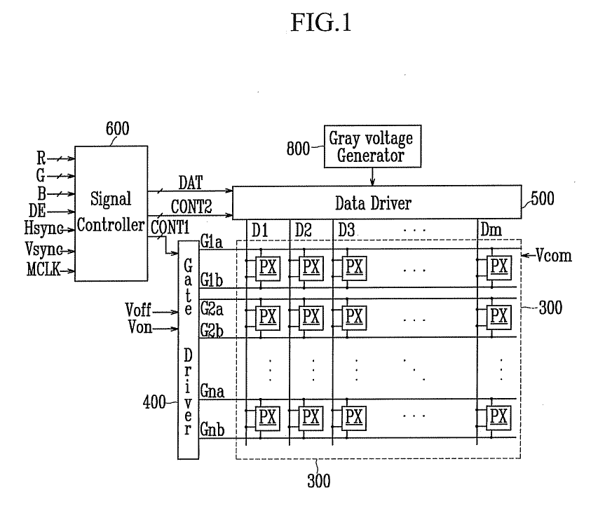

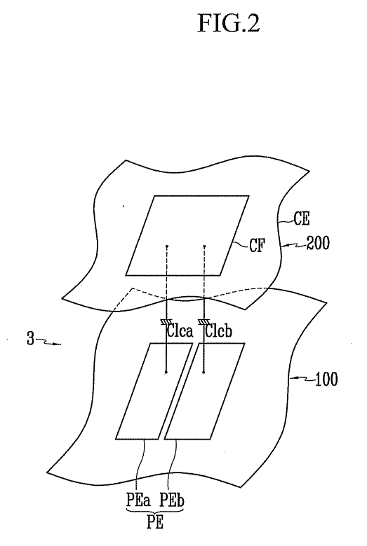

First, an LCD according to an exemplary embodiment of the present invention will be described with reference to FIGS. 1 and 2.

FIG. 1 is a block diagram of an exemplary LCD according to an exemplary embodiment of the present invention, and FIG. 2 is an equivalent circuit diagram of two exemplary subpixels in an exemplary LCD according to an exemplary embodiment of the present invention.

As shown in FIG. 1, an LCD includes a liquid crystal panel assembly 300, a gate driver 400 and a data driver 500 that are connected to the liquid crystal panel assembly 300, a gray voltage generator 800 that is connected to the data driver 500, and a signal controller 600 that controls the above-described elements.

As viewed in an equivalent circuit, the liquid crystal panel assembly 300 includes a plurality of signal lines G₁ₐ to G_{nb} and D₁ to Dₘ, and a plurality of pixels PX that are connected to the plurality of signal lines G₁ₐ to G_{nb} and D₁ to Dₘ and disposed in a matrix. In FIG. 2, the liquid crystal panel assembly 300 includes lower and upper panels 100 and 200 that face each other, and a liquid crystal layer 3 that is interposed between there between.

The signal lines G₁ₐ to G_{nb} and D₁ to Dₘ have a plurality of gate lines G₁ₐ to G_{nb} that transmit gate signals (also referred to as “scanning signals”), and a plurality of data lines D₁ to Dₘ that transmit data signals. The gate lines G₁ₐ to G_{nb} extend in a row direction, a first direction, so as to be substantially parallel to one another, and the data lines D₁ to Dₘ extend in a column direction, a second direction, so as to be substantially parallel to one another. The first direction may be substantially perpendicular to the second direction.

Each of the pixels PX has a pair of subpixels, and each of the subpixels has a liquid crystal capacitor Clca or Clcb. At least one of the two subpixels has a switching element (not shown) that is connected to a gate line, a data line, and a liquid crystal capacitor Clca or Clcb.

The liquid crystal capacitor Clca/Clcb uses a subpixel electrode PEa/PEb of the lower panel 100 and the common electrode CE of the upper panel 200 as two terminals, and the liquid crystal layer 3 between the subpixel electrode PEa/PEb and the common electrode CE functions as a dielectric material. The pair of subpixel electrodes PEa and PEb are separated from each other, and form one pixel electrode PE. The common electrode CE is formed on an entire surface, or substantially an entire surface, of the upper panel 200, and is applied with a common voltage Vcom. The liquid crystal layer 3 has negative dielectric anisotropy, and long axes of liquid crystal molecules in the liquid crystal layer 3 may be perpendicular to the surfaces of the two display panels 100, 200 in the absence of an electric field.

Meanwhile, in order to implement color display, each pixel PX is allowed to display one color from a set of colors, such as primary colors (spatial division), and each pixel is allowed to alternately display the colors with the passage of time (temporal division), which causes desired colors to be recognized by spatial and temporal sums of the colors. Examples of the set of colors may include three colors, such as red, green, and blue. FIG. 2 is an example of a spatial division, which illustrates a case in which each pixel PX has a color filter CF for displaying one of the colors, such as one of the primary colors, in a region of the upper panel 200. Alternatively, the color filter CF may be formed above or below the subpixel electrodes PEa and PEb of the lower panel 100.

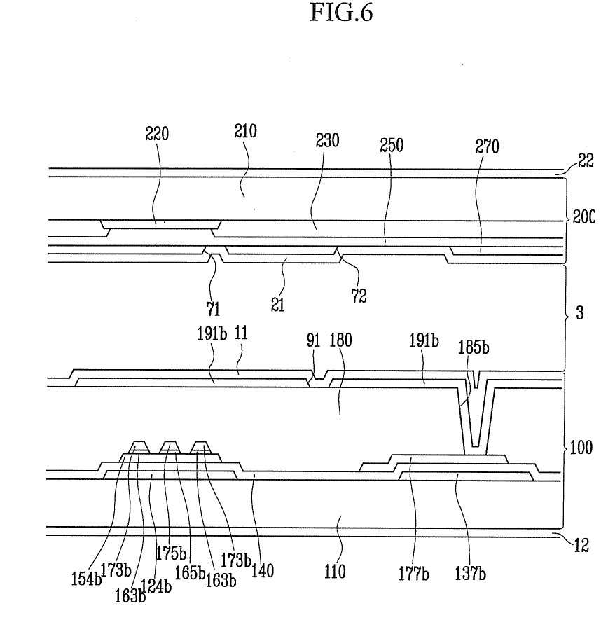

Two polarizers 12 and 22 (see FIG. 6) are provided on external surfaces of the display panels 100 and 200, and polarization axes of the two polarizers may be orthogonal to each other. In a reflective LCD, one of the two polarizers 12 and 22 may be omitted. In a case of a crossed polarizer, light incident on the liquid crystal layer 3 in the absence of an electric field is blocked.

Referring back to FIG. 1, the gray voltage generator 800 generates a plurality of gray voltages (or reference gray voltages) related to the transmittance of the pixels PX. However, the gray voltage generator 800 may generate only a given number of gray voltages instead of generating all of the gray voltages.

The gate driver 400 that is connected to the gate lines G₁ₐ to G_{nb} of the liquid crystal panel assembly 300 applies a gate signal (Vg) that is composed of a gate-on voltage Von and a gate-off voltage Voff to the gate lines G₁ₐ to G_{nb}.

The data driver 500 is connected to the data lines D₁ to Dₘ of the liquid crystal panel assembly 300 and applies data voltages Vd, which are selected from the gray voltages supplied from the gray voltage generator 800, to the data lines D₁ to Dₘ.

However, in a case in which the gray voltage generator 800 does not supply voltages for all grays and supplies only a predetermined number of reference gray voltages, the data driver 500 divides the reference gray voltages to generate gray voltages for all grays, and selects a data signal from the generated gray voltages.

The signal controller 600 controls the gate driver 400 and data driver 500.

Each of the drivers 400, 500, 600, and 800 may be mounted on the liquid crystal panel assembly 300 in a type of at least one integrated circuit (“IC”) chip, mounted on a flexible printed circuit (“FPC”) film (not shown) so as to be attached to the liquid crystal panel assembly 300 in a type of a tape carrier package (“TCP”), or mounted on a separate printed circuit board (“PCB”) (not shown). However, each of the drivers 400, 500, 600, and 800 may be directly integrated on the liquid crystal panel assembly 300. Further, each of the drivers 400, 500, 600, and 800 may be integrated in a single chip. In this case, at least one of the drivers 400, 500, 600, and 800 or at least one circuit of each of the drivers 400, 500, 600, and 800 may be disposed outside the single chip.

A structure of the liquid crystal panel assembly will be further described with reference to FIGS. 3 to 7 and FIGS. 1 and 2.

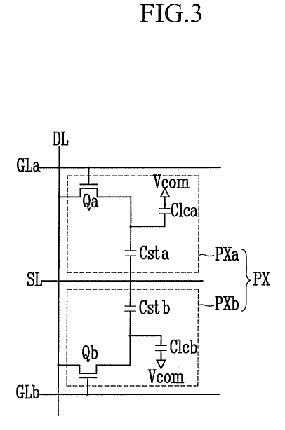

FIG. 3 is an equivalent circuit diagram of one exemplary pixel in a liquid crystal panel assembly according to an exemplary embodiment of the present invention.

Referring to FIG. 3, the liquid crystal panel assembly according to the present exemplary embodiment includes signal lines that have a plurality of pairs of gate lines GLa and GLb, a plurality of data lines DL, and a plurality of storage electrode lines SL, as well as a plurality of pixels PX that are connected to the plurality of signal lines.

Each pixel PX has a pair of subpixels PXa and PXb, and each subpixel PXa/PXb includes a switching element Qa/Qb that is connected to a corresponding gate line GLa/GLb and a corresponding data line DL, a liquid crystal capacitor Clca/Clcb that is connected to the switching element Qa/Qb, and a storage capacitor Csta/Cstb that is connected to the switching element Qa/Qb and the storage electrode line SL.

Each switching element Qa/Qb corresponds to a three-terminal element, such as a thin-film transistor (“TFT”), provided in the lower panel 100, and has a control terminal, such as a gate electrode, connected to a gate line GLa/GLb, an input terminal, such as a source electrode, connected to the data line DL, and an output terminal, such as a drain electrode, connected to the liquid crystal capacitor Clca/Clcb and the storage capacitor Csta/Cstb.

The storage capacitor Csta/Cstb that performs an auxiliary function of the liquid crystal capacitor Clca/Clcb is formed by overlapping the storage electrode line SL and the pixel electrode PE included in the lower panel 100 with an insulator there between. A predetermined voltage, such as a common voltage Vcom, is applied to the storage electrode line SL. However, the storage capacitors Csta and Cstb may be formed by overlapping the subpixel electrodes PEa and PEb and a previous gate line right above the subpixel electrodes PEa and PEb with an insulator there between.

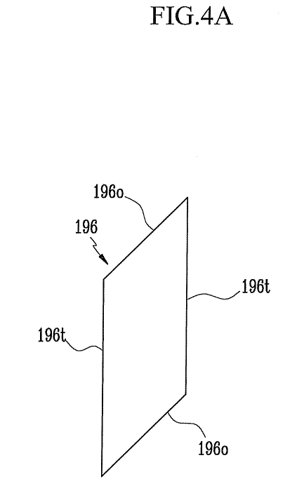

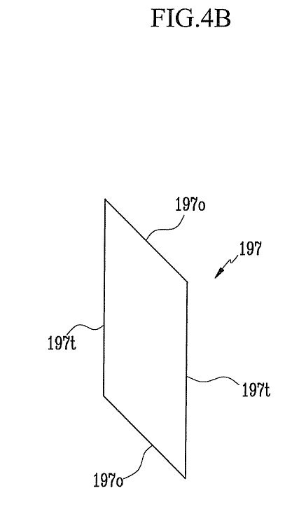

Each of the subpixel electrodes PEa and PEb has at least a parallelogrammic electrode piece 196 as shown in FIG. 4A, and a parallelogrammic electrode piece 197 as shown in FIG. 4B.

As shown in FIGS. 4A and 4B, the electrode piece 196 has a pair of oblique edges 196o and 196o and a pair of lengthwise edges 196t and 196t, the electrode piece 197 has a pair of oblique edges 197o and 197o and a pair of lengthwise edges 197t and 197t, and each of the electrode pieces 196 and 197 is substantially parallelogrammic. The oblique edges 196o and 197o form an oblique angle with respect to the lengthwise edges 196t and 197t, and the oblique angle is preferably within a range of 45 to 135°. For convenience, based on a direction inclined vertical to the lengthwise edges 196t and 197t (“oblique direction”), a case of being inclined rightward as shown in FIG. 4A is referred as “rightward inclination” and a case of being inclined leftward as shown in FIG. 4B is referred as “leftward inclination”.

In the electrode pieces 196 and 197, the length between the lengthwise edges 196t and 197t that is the width, and the length between the oblique edges 196o and 197o, that is the height, can be freely determined according to a size of the liquid crystal display panel assembly 300. Further, in the electrode pieces 196 and 197, the lengthwise edges 196t and 197t may be bent or protruded to deform, considering to the relationship with the other portions, and in the description below, even if all types of deformation are made in the electrode pieces 196 and 197, the electrode pieces 196 and 197 will still be referred to as having parallelogrammic shapes.

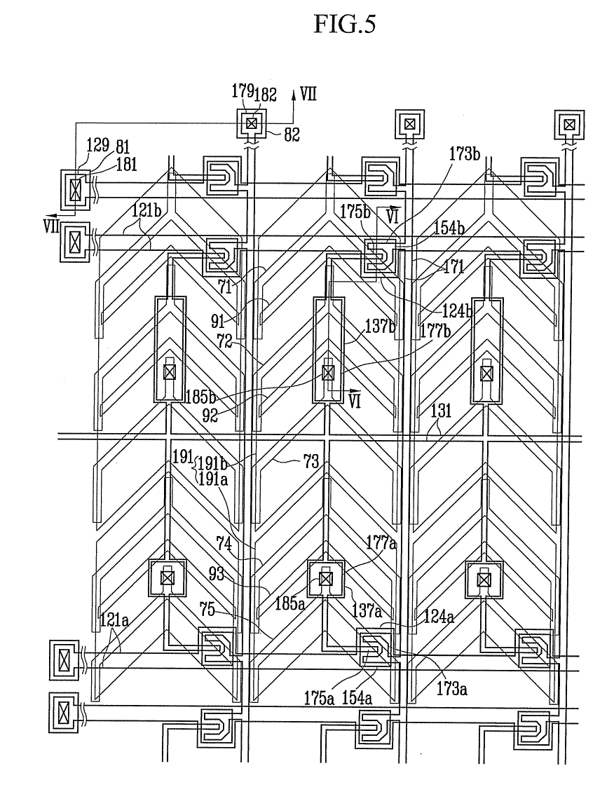

In the first and second subpixel electrodes 191a and 191b, as will be described with reference to FIG. 5, the parallelogrammic electrode pieces 196 and 197, each of which has different inclination, are connected to each other in a row direction. The lengthwise edges 196t and 197t of the parallelogrammic electrode pieces 196 and 197 come into contact with each other. The oblique edges 196o and 197o of the parallelogrammic electrode pieces 196 and 197 are connected to each other to form an oblique angle or a right angle, and the oblique angle is preferably about 90°.

The first and second subpixel electrodes 191a and 191b are adjacent to each other in a column direction. The height of the second subpixel electrode 191b is larger than that of the first subpixel electrode 191a. Specifically, the height of the second subpixel electrode 191b is larger than that of the first subpixel electrode 191a within a range of 1.1 to 2 times thereof. The width of the second subpixel electrode 191b is slightly larger than that of the first subpixel electrode 191a. Accordingly, the area of the second subpixel electrode 191b is larger than that of the first subpixel electrode 191a, specifically within a range of 1.5 to 2 times thereof. However, the present invention is not limited thereto, and a desired area ratio between the first and second subpixel electrodes 191a and 191b can be obtained by adjusting the height and the width of each of the first and second subpixel electrodes 191a and 191b. Preferably, the area ratio between the first and second subpixel electrodes 191a and 191b is within a range of 1:1.1 to 1:3.

As such, each of the first and second subpixel electrodes 191a and 191b is bent once in a horizontal direction. In other words, each of the first and second subpixel electrodes 191a and 191b may have a substantially simple concave hexagon shape formed in an arrow shape with one concavity. By simple, it should be understood that the outside edges do not cross. A convex portion of the first subpixel electrodes 191a (the pointed portion of the arrow shape) may be nested within the concavity of adjacent second subpixel electrodes 191b, and a convex portion of the second subpixel electrodes 191b may be nested within the concavity of adjacent first subpixel electrodes 191a. Thus, the first and second subpixel electrodes 191a and 191b are nested alternatingly in the column direction. Accordingly, it is possible to easily form regions of the three pixel electrodes 191 that correspond to a color filter CF for displaying one of the three colors in the set of colors including red (R), green (G), and blue (B). Further, areas overlapping the data lines 171a and 171b, as will also be described with reference to FIG. 5, may be easily adjusted.

In the LCD including the liquid crystal panel assembly 300, the signal controller 600 receives input image signals R, G, and B for each pixel PX, converts them into a plurality of output image data DAT for two subpixels PXa and PXb to be supplied to the data driver 500. Otherwise, the gray voltage generator 800 generates separate groups of gray voltages for two subpixels PXa and PXb. The two groups of gray voltages are alternately supplied by the gray voltage generator 800 to the data driver 500 or alternately selected by the data driver 500 such that the two subpixels PXa and PXb are supplied with different voltages. At this time, the values of the converted output image signals and the values of the gray voltages in each group are preferably determined such that the synthesis of gamma curves for the two subpixels PXa and PXb approaches a reference gamma curve at a front view. For example, the synthesized gamma curve at the front view coincides with the suitable gamma curve at a front view, and the synthesized gamma curve at a lateral curve at a lateral view is the most similar to the gamma at a front view.

Hereinafter, an example of the LCD shown in FIG. 3 will be described with reference to FIGS. 5 to 7 and FIGS. 1 and 2.

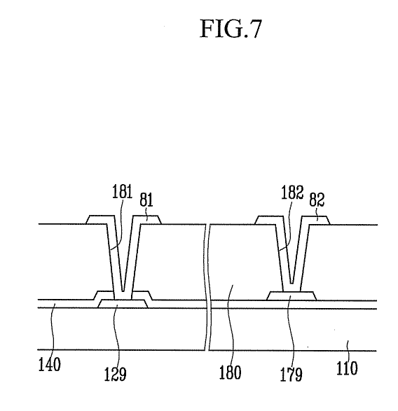

FIG. 5 is a layout view of an exemplary LCD according to an exemplary embodiment of the present invention, and FIGS. 6 and 7 are cross-sectional views taken along lines VI-VI and VII-VII in the exemplary LCD shown in FIG. 5.

Referring to FIGS. 5 to 7, the liquid crystal panel assembly includes a lower panel 100 and an upper panel 200 that face each other, and a liquid crystal layer 3 that is interposed between the two display panels 100 and 200.

First, the lower panel 100 will be described.

A plurality of gate conductors that include a plurality of pairs of first and second gate lines 121a and 121b and a plurality of storage electrode lines 131 are formed on an insulation substrate 110 such as transparent glass or plastic.

The first and second gate lines 121a and 121b transmit gate signals and extend in a transverse direction, a first direction. The first gate line 121a is located above the second gate line 121b.

The first gate line 121a has a plurality of first gate electrodes 124a projecting downward towards the second gate line 121b, and a wide end 129 for connection with other layers and the gate driver 400. The second gate line 121b has a plurality of second gate electrodes 124b projecting upward towards the first gate line 121a, and a wide end 129 for connection with other layers and the gate driver 400. The gate lines 121a and 121b may extend to be connected to a gate driver 400 that may be integrated on the substrate 110.

The storage electrode lines 131 are supplied with a predetermined voltage, such as a common voltage Vcom, and extend in a transverse direction, the first direction. Each of the storage electrode lines 131 is located between the first gate line 121a and the second gate line 121b. Each of the storage electrode lines 131 includes portions extending in a vertical direction, and includes storage electrodes 137a and 137b extending from portions of the storage electrode lines 131. However, the storage electrode lines 131 may have various shapes and arrangements.

Each of the gate conductors 121a, 121b, and 131 may be made of an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), titanium (Ti), and the like. However, the gate conductors may have a multilayer structure that has two or more conductive layers (not shown) whose physical properties are different from each other. In order to reduce signal delay or voltage drop, one of the two conductive layers in a two layer structure is made of a metal having low resistivity, for example, an aluminum-based metal, a silver-based metal, a copper-based metal, and the like, while the other conductive layer is made of materials that are excellent in terms of physical, chemical, and electrical contact characteristics with, particularly, indium tin oxide (“ITO”) and indium zinc oxide (“IZO”), for example, a molybdenum-based metal, chromium, tantalum, titanium and the like. Preferable examples of material configurations of the two conductive layers may include a chromium lower layer and an aluminum (alloy) upper layer, and an aluminum (alloy) lower layer and a molybdenum (alloy) upper layer. However, each of the gate conductors 121a, 121b, and 131 may be made of not only the above-mentioned materials but also various metals or various conductors.

The lateral sides of the gate conductors 121a, 121b, and 131 are inclined relative to a surface of the substrate 110, and the inclination angle thereof ranges about 30 to about 80 degrees.

A gate insulating layer 140 that may be made of silicon nitride (SiNx) or silicon oxide (SiOx) is formed on the gate conductors 121a, 121b, and 131 and on exposed portions of the insulation substrate 110.

A plurality of first and second semiconductor islands 154a and 154b, which are made of hydrogenated amorphous silicon (“a-Si”) or polysilicon, are formed on the gate insulating layer 140. The first and second semiconductors 154a and 154b are disposed on the first and second gate electrodes 124a and 124b.

A pair of ohmic contact islands (ohmic contacts) 163a and 165a are formed on each first semiconductor 154a, and a pair of ohmic contact islands (not shown) are formed above each second semiconductor 154b. Each of the ohmic contacts 163a and 165a may be made of a material, such as n+ hydrogenated a-Si, in which n-type impurities, such as phosphor, are doped with a high concentration, or a material such as silicide.

The lateral sides of the semiconductor islands 154a and 154b and the ohmic contacts 163b and 165b are inclined relative to the surface of the substrate 110, and the inclination angles thereof may be in a range of about 30 to about 80 degrees.

Data conductors that include a plurality of data lines 171 and a plurality of pairs of first and second drain electrodes 175a and 175b are formed on the ohmic contacts 163a and 165a and the gate insulating layer 140.

The data lines 171 transmit data signals, and extend in the longitudinal direction, a second direction substantially perpendicular to the first direction, to intersect the gate lines 121a and 121b and the storage electrode line 131. Each of the data lines 171 includes a plurality of pairs of first and second source electrodes 173a and 173b that extend to the first and second gate electrodes 124a and 124b, and a wide end 179 for connection with other layers or the data driver 500. The data lines 171 may extend to be connected to a data driver 500 that may be integrated on the substrate 110.

The first and second drain electrodes 175a and 175b are separated from each other, and are also separated from the data lines 171. The first/second drain electrode 175a/175b faces the first/second source electrode 173a/173b over the first/second gate electrode 124a/124b, and has one wide end 177a/177b and one rod-shaped end. The wide end 177a of the first drain electrode 175a is larger in area than the wide end 177b of the second drain electrode 175b. The wide ends 177a and 177b overlap the storage electrodes 137a and 137b, and portions of the rod-shaped ends of the first and second drain electrodes 175a and 175b are surrounded with the first and second source electrodes 173a and 173b that are bent, such as in a “C”.

The first/second gate electrodes 124a/124b, the first/second source electrodes 173a/173b, and the first/second drain electrodes 175a/175b form the first/second TFTs Qa/Qb together with the first/second semiconductors 154a/154b, and channels of the first/second TFTs Qa/Qb are formed in the first/second semiconductors 154a/154b between the first/second source electrodes 173a/173b and the first/second drain electrodes 175a/175b. In the illustrated embodiment, the first/second TFTs Qa/Qb are located at the left side of the data lines 171, however alternate locations would also be within the scope of these embodiments.

Each of the data conductors 171, 175a, and 175b is preferably made of refractory metals, such as molybdenum, chromium, tantalum, and titanium, or an alloy thereof, or may have a multilayer structure that includes a refractory metal film (not shown) and a conductive layer (not shown) having low resistance. Preferable examples of the multilayer structure may include a double layer having a chromium or molybdenum (alloy) lower layer and an aluminum (alloy) upper layer, and a triple layer having a molybdenum (alloy) lower layer, an aluminum (alloy) intermediate layer, and a molybdenum (alloy) upper layer. However, the data conductors 171, 175a, and 175b may be made of not only the above-mentioned materials but also various metals or conductors.

The data conductors 171, 175a, and 175b have inclined edge profiles, and the inclination angles thereof range about 30 to about 80 degrees with respect to the substrate 110.

The ohmic contacts 163a and 165a are interposed only between the semiconductors 154a and 154b that are below the ohmic contacts 163a and 165a and the data conductors 171, 175a, and 175b that are above the ohmic contacts 163a and 165a so as to lower contact resistance between them. The semiconductors 154a and 154b include, in addition to regions between the source electrodes 173a and 173b and the drain electrodes 175a and 175b, portions that are not covered with the data conductors 171, 175a, and 175b.

A passivation layer 180 is formed on the data conductors 171, 175a, and 175b, and the exposed portions of the semiconductors 154a and 154b, as well as on exposed portions of the gate insulating layer 140. The passivation layer 180 is made of an inorganic insulator or an organic insulator, and may have a flat surface. Preferably, the organic insulator has a dielectric constant of 4.0 or less, and it may have photosensitivity. However, the passivation layer 180 may have a dual-layer structure including a lower inorganic layer and an upper organic layer, such that it does not damage the exposed portions of the semiconductors 154a and 154b while sufficiently using the excellent insulating characteristic of an organic film.

In the passivation layer 180, a plurality of contact holes 182, 185a, and 185b to which an end 179 of the data line 171 and wide ends 177a and 177b of the first and second drain electrodes 175a and 175b are exposed are formed, and in the passivation layer 180 and the gate insulating layer 140, a plurality of contact holes 181 to which ends 129 of the gate lines 121a and 121b are exposed are formed.

A plurality of pixel electrodes 191 and a plurality of contact assistants 81 and 82 are formed on the passivation layer 180. Each of the pixel electrodes 191 and the contact assistants 81 and 82 may be made of a transparent conductive material such as ITO or IZO, or a reflective metal such as aluminum, silver, chromium, or an alloy thereof.

Each of the pixel electrodes 191 is formed on the lower panel 100, and faces a color filter CF that each represents one color in a set of colors, such as red (R), green (G), and blue (B). Each pixel electrode 191 has a pair of the first and second subpixel electrodes 191a and 191b that are separated from each other. The first and second subpixel electrodes 191a and 191b are adjacent to each other in a column direction, and the first subpixel electrode 191a has cutouts 93 and the second subpixel electrode 191b has a cutout 91 and 92. Further, the common electrode 270 that faces the pixel electrodes 191 has a plurality of cutouts 71, 72, 73, 74, and 75.

Each of the first and second subpixel electrodes 191a and 191b has at least one parallelogrammic electrode piece 196 as shown in FIG. 4A and a parallelogrammic electrode piece 197 as shown in FIG. 4B. The electrode pieces 196 and 197 shown in FIG. 4A and FIG. 4B are connected in a horizontal direction to form a basic electrode, and each of the subpixel electrodes 191a and 191b has a structure based on the basic electrode, as previously described above with respect to FIGS. 4A and 4B, and thus a detailed description thereof will not be repeated.

The first subpixel electrode 191a is connected to each first drain electrode 175a via the wide end 177a through a contact hole 185a, and the second subpixel electrode 191b is connected to each second drain electrode 175b via the wide end 177b through the contact hole 185b.

The first/second subpixel electrodes 191a and 191b and the common electrode 270 of the upper panel 200, and the liquid crystal layer 3 formed between them, form the first/second liquid crystal capacitors Clca/Clcb, and hold an applied voltage even after the TFTs (Qa/Qb) are turned off.

The first/second subpixel electrodes 191a and 191b and the first/second drain electrodes 175a and 175b that are connected to the first/second subpixel electrodes 191a and 191b overlap the storage electrode 137 with a gate insulating layer 140 interposed there between so as to form the first/second storage capacitors Csta/Cstb, and the first/second storage capacitors Csta/Cstb reinforce the voltage maintaining capability of the first/second liquid crystal capacitors (Clca/Clcb).

The contact assistants 81 and 82 are connected to the ends 129 of the gate lines 121a and 121b and an end 179 of the data line 171 through the contact holes 181 and 182. The contact assistants 81 and 82 complement connection between the ends 129 of the gate lines 121a and 121b and the end 179 of the data line 171, and an external device, and protect them.

Next, the upper panel 200 will be described.

A light blocking member 220 is formed on an insulation substrate 210 such as, but not limited to, transparent glass or plastic. The light blocking member 220 may have a bent portion (not shown) that corresponds to a bent edge of each pixel electrode 191, and a quadrangle portion (not shown) that corresponds to each TFT. The light blocking member 220 prevents light leakage between the pixel electrodes 191 and defines an opening region that faces the pixel electrode 191.

A plurality of color filters 230 are also formed on the substrate 210 and the light blocking member 220. The color filters 230 mainly exist in a region surrounded by the light blocking member 220, and may extend to be elongated respectively along a column of the pixel electrodes 191. Each of the color filters 230 may display one of three colors, such as primary colors, including red, green, and blue.

An overcoat 250 is formed on the color filter 230 and the light blocking member 220. The overcoat 250 may be made of an organic insulator, and prevents the color filter 230 from being exposed and provides a flat surface. Alternatively, the overcoat 250 may be omitted.

The common electrode 270 is formed on the overcoat 250. The common electrode 270 is formed of a transparent conductor, such as ITO, IZO, or the like, and has a plurality of cutouts 71 to 75.

The number of cutouts 71 to 75 may be different according to the design, and the light blocking member 220 may overlap the cutouts 71 to 75 so as to block light leakage near the cutouts 71 to 75.

Alignment layers 11 and 21 may be formed on inner surfaces of the display panels 100 and 200, and they may be vertical alignment layers.

On outer surfaces of the display panel 100 and 200, polarizers 12 and 22 are provided. Preferably, the polarization axes of the two polarizers 12 and 22 are orthogonal to each other, and form an angle of about 45° with respect to the oblique edges of the subpixel electrodes 191a and 191b. In the case of a reflective LCD, one of the two polarizers 12 and 22 may be omitted.

The LCD may include a lighting unit (backlight unit) (not shown) that supplies light to the polarizers 12 and 22, a phase delay film, the display panels 100 and 200, and the liquid crystal layer 3.

The liquid crystal layer 3 has negative dielectric anisotropy, and long axes of the liquid crystal molecules of the liquid crystal layer 3 are perpendicular to the surfaces of the two display panels 100, 200 in the absence of an electric field.

The cutouts 71 to 75 may be substituted with protrusions (not shown) or depressions (not shown). The protrusions may be made of organic materials or inorganic materials, and are disposed above or below the field generating electrodes 191 and 270.

An exemplary operation of the LCD shown in FIGS. 1 to 7 will now be further described.

The signal controller 600 receives input image signals R, G, and B and input control signals for controlling display of the input image signals R, G, and B from an external graphic controller (not shown). The input image signals R, G, and B contain luminance information of each pixel PX, and the luminance has grays of the predetermined number, for example 1024 (=2¹⁰), 256 (=2⁸) or 64 (=2⁶). Examples of the input control signals include a vertical synchronization signal Vsync, a horizontal synchronizing signal Hsync, a main clock signal MCLK, a data enable signal DE, and the like.

The signal controller 600 appropriately processes the input image signals R, G, and B according to the operation conditions of the liquid crystal panel assembly 300 and the data driver 500 on the basis of the input image signals R, G, and B and input control signals, generates a gate control signal CONT1, a data control signal CONT2, and the like so as to transmit the gate control signal CONT1 to the gate driver 400, and outputs the data control signal CONT2 and the processed image signal DAT to the data driver 500. The output image signals DAT are digital signals having a predetermined number of values (or grays).

The gate control signal CONT1 includes a scanning start signal STV that instructs a scanning start operation and at least one clock signal that controls an output cycle of the gate-on voltage Von. The gate control signal CONT1 may further include an output enable signal OE that defines a duration time of the gate-on voltage Von.

The data control signal CONT2 includes a horizontal synchronization start signal STH that instructs a transmission start of image data operation for a group of pixels PX, a load signal LOAD that instructs application of a data signal Vd to the liquid crystal panel assembly 300, and a data clock signal HCLK. The data control signal CONT2 may further include an inversion signal RVS that inverts a voltage polarity of a data signal Vd for the common voltage Vcom (hereinafter, “a voltage polarity of a data signal for the common voltage” is simply referred to as polarity of “a data signal”).

In accordance with the data control signal CONT2 supplied by the signal controller 600, the data driver 500 receives digital image signals DAT for a group of pixels, selects gray voltages corresponding to the respective digital image signals DAT, converts the digital image signals DAT into analog data signals Vd, and applies the converted signals to the corresponding data lines 171.

In accordance with the gate control signal CONT1 supplied by the signal controller 600, the gate driver 400 applies the gate-on voltage Von to the gate lines 121a and 121b, and turns on switching elements Qa and Qb that are connected to the gate lines 121a and 121b. Then, the data signal Vd supplied to the data line 171 is applied to the corresponding subpixels PXa and PXb through the switching elements Qa and Qb that are turned on.

If a potential difference is generated across the first and second liquid crystal capacitors Clca and Clcb, a primary electric field that is substantially vertical to the surfaces of the display panels 100 and 200 is generated in the liquid crystal layer 3. (Hereinafter, the pixel electrodes 191 and the common electrode 270 are referred to as “field generating electrodes”.) Then, long axes of the liquid crystal molecules of the liquid crystal layer 3 are perpendicular to a direction in which an electric field is applied in response to the applied electric field, the variation of the polarization of the light incident on the liquid crystal layer 3 is different according to the inclination of the liquid crystal molecules. When the polarization varies, the transmittance is changed by the polarizers 12 and 22, and thus the LCD displays images.

Tilt angles of the liquid crystal molecules within the liquid crystal layer 3 depend on the intensity of the electric field. Since the voltages of the two liquid crystal capacitors Clca and Clcb are different from each other, the tilt angles of the liquid crystal molecules within the liquid crystal layer 3 are different. As a result, luminance is different in the two subpixels PXa and PXb. Accordingly, if the voltage of the first liquid crystal capacitor Clca and the voltage of the second liquid crystal capacitor Clcb are appropriately adjusted, an image in a lateral view may be maximally close to an image in a front view, that is, a lateral gamma curve may be maximally close to a front gamma curve, and thus lateral visibility may be improved.

Further, if the area of the first subpixel electrode 191a applied with a high voltage is made to be smaller than the area of the second subpixel electrode 191b, the lateral gamma curve can be made to be closer to the front gamma curve, and thus lateral visibility can be improved. In particular, within exemplary embodiments of the present invention, in one pixel electrode group, the width and the height of each of the subpixel electrodes 191a and 191b may be freely adjusted. Therefore, an area ratio between the first subpixel electrode 191a and the second subpixel electrodes 191b may be freely adjusted.

Tilt directions of the liquid crystal molecules within the liquid crystal layer 3 are primarily determined according to horizontal components obtained by distorting the primary electric field by the cutouts 71 to 75 and 91 to 93 of the field generating electrodes 270 and 191, respectively, and the edges of the subpixel electrodes 191a and 191b. The horizontal component of this primary electric field is substantially vertical to the edges of the cutouts 71 to 75 and 91 to 93 and the edges of the subpixel electrodes 191a and 191b.

The subpixels PXa and PXb are divided into a plurality of sub-areas by the cutouts 71 to 75 and 91 to 93, and each of the sub-areas has two major edges that are defined by bent portions of the cutouts 71 to 75 and 91 to 93 and the bent edges of the subpixel electrodes 191a and 191b. The liquid crystal molecules in each sub-area are tilted in directions vertical to the major edges, that is, in substantially four directions. As such, as the tilt directions of liquid crystal molecules are diversified, a reference viewing angle of the LCD is increased.

Meanwhile, a direction of a secondary electric field that is generated by the voltage difference between the subpixel electrodes 191a and 191b is vertical to the major edges of the sub-areas. Therefore, a direction of the secondary electric field is equal to a direction of the horizontal component of the primary electric field. As a result, the secondary electric field between the subpixel electrodes 191a and 191b determines a tilt direction of the liquid crystal molecules within the liquid crystal layer 3.

The above-described processes are repeated in a unit of one horizontal period (also referred to as “1H” that is equal to a cycle of each of a horizontal synchronizing signal Hsync and a data enable signal DE), and data signals Vd are applied to all pixels PX, thereby displaying images of one frame.

After one frame is completed, a next frame starts, and an inversion signal RVS applied to the data driver 500 is controlled such that the polarity of a data signal Vd applied to each pixel PX is opposite to that of the previous frame (“frame inversion”). At this time, in one frame, the polarity of a data signal Vd flowing through one data line 171 is changed according to characteristic of the inversion signal RVS (for example: row inversion and dot inversion), or polarities of data signals Vd applied to one group of pixels PX may be different (for example: column inversion and dot inversion).

Hereinafter, a liquid crystal assembly according to another exemplary embodiment of the present invention will be described with reference to FIGS. 8 and 9 and FIGS. 1 and 2.

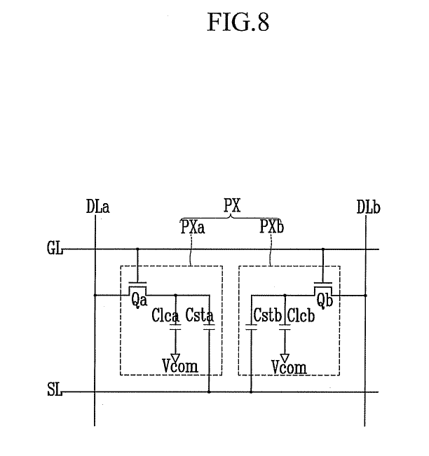

FIG. 8 is an equivalent circuit diagram of one exemplary pixel in an exemplary liquid crystal panel according to another exemplary embodiment of the present invention.

Referring to FIG. 8, the liquid crystal panel assembly includes a plurality signal lines that include a plurality of gate lines GL, a plurality of pairs of data lines DLa and DLb, and a plurality of storage electrode lines SL, and a plurality of pixels PX that are connected to the signal lines.

Each of the pixels PX has a pair of subpixels PXa and PXb, and each of the subpixels PXa/PXb has a switching element Qa/Qb that is connected to a corresponding gate line GL and a corresponding data line DLa/DLb, a liquid crystal capacitor Clca/Clcb that is connected to the switching element Qa/Qb, and a storage capacitor Csta/Cstb that is connected to the switching element Qa/Qb and the storage electrode line SL.

Each of the switching elements Qa/Qb also corresponds to a three-terminal element, such as a TFT, that is included in the lower panel 100, and has a control terminal, such as a gate electrode, connected to a gate line GL, an input terminal, such as a source electrode, connected to a data line DLa/DLb, and an output terminal, such as a drain electrode, connected to the liquid crystal capacitor Clca/Clcb and the storage capacitor Csta/Cstb.

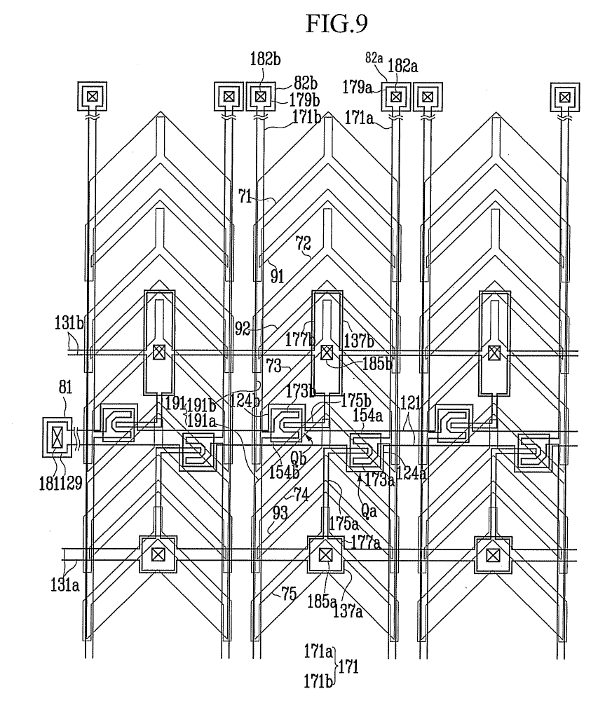

The operation of the LCD that includes the liquid crystal capacitors Clca and Clcb, the storage capacitors Csta and Cstb, and the liquid crystal panel assembly is substantially the same as that in the LCD according to the above-described exemplary embodiment, and thus a detailed description thereof will be omitted. In the LCD shown in FIGS. 3 to 7, the two subpixels PXa and PXb that form one pixel PX are applied with a data voltage with a time difference there between, while in the present exemplary embodiment shown in FIGS. 8 and 9, the two subpixels PXa and PXb are applied with the data voltage at the same time.

An example of the liquid crystal panel assembly shown in FIG. 8 will now be further described with reference to FIG. 9.

FIG. 9 is a layout view of an exemplary liquid crystal panel assembly according to another exemplary embodiment of the present invention.

As shown in FIG. 9, the liquid crystal panel assembly includes a lower panel 100 and an upper panel 200 that face each other, a liquid crystal layer 3 that is formed between the two display panels 100, 200, and a pair of polarizers (not shown) that adhere to external surfaces of the display panels 100 and 200.

A layered structure of the liquid crystal panel assembly according to the exemplary embodiment of FIGS. 8 and 9 is substantially the same as a layered structure of the liquid crystal panel assembly shown in FIGS. 5 to 7.

The lower panel of the illustrated embodiment of FIGS. 8 and 9 will now be described. On the insulation substrate (not shown), a plurality of gate conductors that include a plurality of gate lines 121 and a plurality of pairs of first and second storage electrode lines 131a and 131b are formed. Each of the gate lines 121 has a plurality of pairs of first and second gate electrodes 124a and 124b, and an end 129. The first and second gate electrodes 124a and 124b may extend in opposite directions from the gate lines 121. The storage electrode lines 131a and 131b have a plurality of storage electrodes 137a and 137b. Each of the storage electrodes 137a and 137b may extend in both directions from the storage electrode lines 131a and 131b, respectively. On the gate conductors 121, 131a, and 131b and the insulation substrate, a gate insulating layer (not shown) is formed. On the gate insulating layer, a plurality of semiconductor islands 154a and 154b are formed, and on the plurality of semiconductor islands 154a and 154b, ohmic contacts (not shown) are formed. On the ohmic contacts, data conductors that include a plurality of pairs of first and second data lines 171a and 171b and a plurality of first and second drain electrodes 175a and 175b are formed. The first and second data lines 171a and 171b include a plurality of first and second source electrodes 173a and 173b and ends 179a and 179b, and the first and second drain electrodes 175a and 175b include extending portions 177a and 177b. On the data conductors 171a, 171b, 175a, and 175b, exposed portions of the semiconductors 154a and 154b, and the gate insulating layer, a passivation layer (not shown) is formed, and a plurality of contact holes 181, 182a, 182b, 185a, and 185b are formed in the passivation layer and the gate insulating layer. A plurality of pixel electrodes 191 that include the first and second subpixel electrodes 191a and 191b and a plurality of contact assistants 81, 82a, and 82b are formed on the passivation layer. The first and second subpixel electrodes 191a and 191b have structures including the parallelogrammic electrode pieces 196, 197 shown in FIGS. 4A and 4B, as in the liquid crystal panel shown in FIG. 5. The first subpixel electrode 191a is provided a cutout 93, and the second subpixel electrode 191b is provided with cutouts 91 and 92 An alignment layer (not shown) is formed on the pixel electrodes 191, the contact assistants 81, 82a, and 82b, and the passivation layer.

The upper panel 200 will now be described. On an insulation substrate, a light blocking member, a plurality of color filters, an overcoat, a common electrode having cutouts 71, 72, 73, 74, and 75, and an alignment layer are formed.

However, in the liquid crystal panel assembly according to the illustrated embodiment of FIGS. 8 and 9, as compared with the liquid crystal panel assembly shown in FIGS. 5 to 7, the number of gate lines 121 is half, and the number of data lines 171a and 171b is double. In addition, according to the illustrated embodiment of FIGS. 8 and 9, the first and second TFTs Qa and Qb that are connected to the first and second subpixel electrodes 191a and 191b for forming one pixel electrode 191 are connected to the same gate line 121 and different data lines 171a and 171b.

The first and second TFTs Qa and Qb are located at the left side or the right side of the first and second data lines 171a and 171b.

A variety of characteristics of the liquid crystal panel assembly shown in FIGS. 5 to 7 may be applied to the liquid crystal panel assembly shown in FIGS. 8 and 9.

Next, a liquid crystal panel assembly according to another exemplary embodiment of the present invention will be described with reference to FIGS. 10 and 11 and FIGS. 1 and 2.

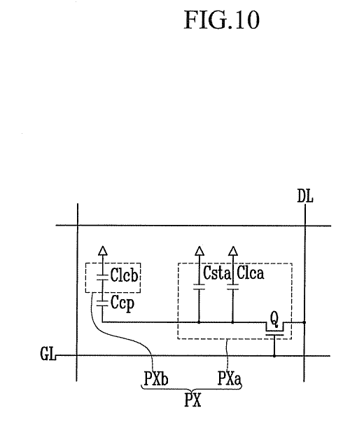

FIG. 10 is an equivalent circuit diagram of one exemplary pixel in an exemplary liquid crystal panel assembly according to another exemplary embodiment of the present invention.

Referring to FIG. 10, the liquid crystal panel assembly includes signal lines that include a plurality of gate lines GL and a plurality of data lines DL, and a plurality of pixels PX that are connected to the signal lines.

Each of the pixels PX has a pair of first and second subpixels PXa and PXb, and a coupling capacitor Ccp that is connected between the two subpixels PXa and PXb.

The first subpixel PXa has a switching element Q that is connected to a corresponding gate line GL and a corresponding data line DL, and a first liquid crystal capacitor Clca and a storage capacitor Csta that are connected to the switching element Q. The second subpixel PXb has a second liquid crystal capacitor Clcb that is connected to a coupling capacitor Ccp that connects the second subpixel PXb to the first subpixel PXa.

The switching element Q also corresponds to a three-terminal element such as a TFT that is included in the lower panel 100, and has a control terminal, such as a gate electrode, connected to a gate line GL, an input terminal, such as a source electrode, connected to a data line DL, and an output terminal, such as a drain electrode, connected to a liquid crystal capacitor Clca, a storage capacitor Csta, and a coupling capacitor Ccp.

In accordance with the gate signal supplied through the gate line GL, the switching element Q applies a data voltage supplied through the data line DL to the first liquid crystal capacitor Clca and the coupling capacitor Ccp, and the coupling capacitor Ccp changes an amplitude of the data voltage and applies the changed voltage to the second liquid crystal capacitor Clcb.

If the storage capacitor Csta is applied with a common voltage Vcom and the capacitors Clca, Csta, Clcb, and Ccp and capacitances thereof are denoted by the same reference indicia, the relationship between the voltage Va charged in the first liquid crystal capacitor Clca and the voltage Vb charged in the second liquid crystal capacitor Clcb is as follows.
Vb=Va×[Ccp/(Ccp+Clcb)] [Equation 1]

Since a value of Ccp/(Ccp+Clcb) is smaller than 1, the voltage Vb charged in the second liquid crystal capacitor Clcb is always smaller than the voltage Va charged in the first liquid crystal capacitor Clca. The relationship is realized even if the voltage applied to the storage capacitor Csta is not the common voltage Vcom.

An appropriate ratio between the voltage Va of the first liquid crystal capacitor Clca and the voltage Vb of the second liquid crystal capacitor Clcb can be obtained by adjusting a capacitance of the coupling capacitor Ccp.

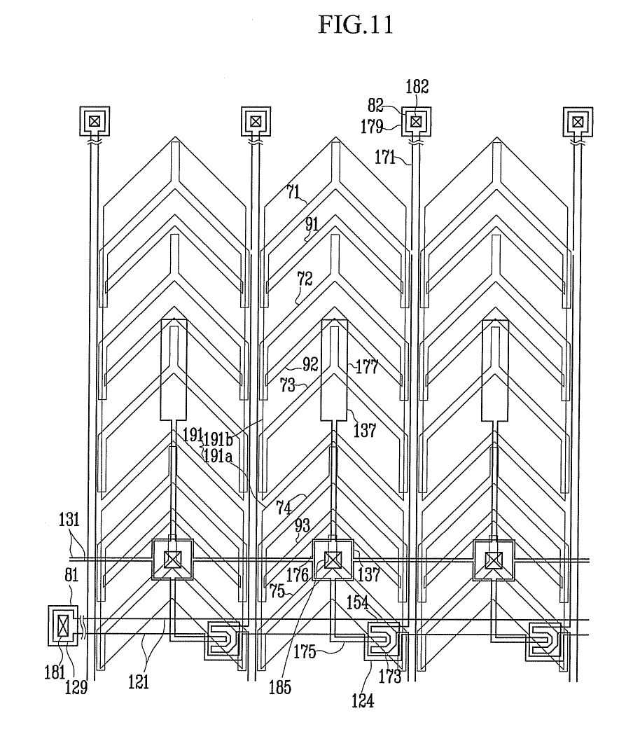

An example of the liquid crystal panel assembly of FIG. 10 will now be further described with reference to FIG. 11.

FIG. 11 is a layout view of an exemplary liquid crystal panel assembly according to another exemplary embodiment of the present invention.

Referring to FIG. 11, the liquid crystal panel assembly according to the present exemplary embodiment includes a lower panel 100 and an upper panel 200 that face each other, a liquid crystal layer 3 that is interposed between the two display panels 100, 200, and a pair of polarizers (not shown) that adhere to external surfaces of the display panels 100 and 200.

A layered structure of the liquid crystal panel assembly according to the illustrated embodiment of FIG. 11 is substantially the same as that of the liquid crystal panel assembly shown in FIGS. 5 to 7.

The lower panel 100 will now be described. On the insulation substrate (not shown), a plurality of gate conductors that include a plurality of gate lines 121 and a plurality of storage electrode lines 131 are formed. Each of the gate lines 121 has a plurality of gate electrodes 124 and an end 129. A gate insulating layer (not shown) is formed on the gate lines 121 and on the insulation substrate. On the gate insulating layer, a plurality of semiconductor islands 154 are formed, and a plurality of ohmic contact islands (not shown) are formed on the plurality of semiconductor islands 154. Data conductors that include a plurality of data lines 171 and a plurality of drain electrodes 175 are formed on the ohmic contacts and the gate insulating layer. Each of the data lines 171 has a plurality of source electrodes 173 and an end 179. A passivation layer (not shown) is formed on the data conductors 171 and 175 and exposed portions of the semiconductors 154, and a plurality of contact holes 181, 182, and 185 are formed in the passivation layer and the gate insulating layer. A plurality of pixel electrodes 191 that include the first and second subpixel electrodes 191a and 191b and a plurality of contact assistants 81 and 82 are formed on the passivation layer. Cutouts 91 and 92 are formed on the second subpixel electrode 191b, and a cutout 93 is formed on the first subpixel electrode 191a. An alignment layer (not shown) is formed on the pixel electrode 191, the contact assistants 81 and 82, and the passivation layer.

The upper panel 200 will now be described. On an insulation substrate, a light blocking member, a plurality of color filters, an overcoat, a common electrode having cutouts 71, 72, 73, 74, and 75, and an alignment layer are sequentially formed.

In the liquid crystal panel assembly according to the exemplary embodiment of FIGS. 10 and 11, as compared with the liquid crystal panel assembly shown in FIGS. 5 to 7, the number of gate lines 121 is half, and only one TFT Q exists per pixel electrode 191.

The drain electrode 175 that forms the TFT Q includes a rod-shaped end, first and second extension portions 176 and 177, and a connection portion that connects the two extension portions 176 and 177. Hereinafter, the second extension portion 177 is referred to as a “coupling electrode”. The first subpixel electrode 191a is connected to the drain electrode 175 through a contact hole 185 to which the first extension portion 176 of the drain electrode 175 is exposed. The coupling electrode 177 is overlapped by the second subpixel electrode 191b so as to form a coupling capacitor Ccp.

A variety of characteristics of the liquid crystal panel assembly shown in FIGS. 5 to 7 may be applied to the liquid crystal panel assembly shown in FIGS. 10 and 11.

A liquid crystal panel assembly according to another exemplary embodiment of the present invention will be described with reference to FIGS. 12 and 13, and FIGS. 1 and 2.

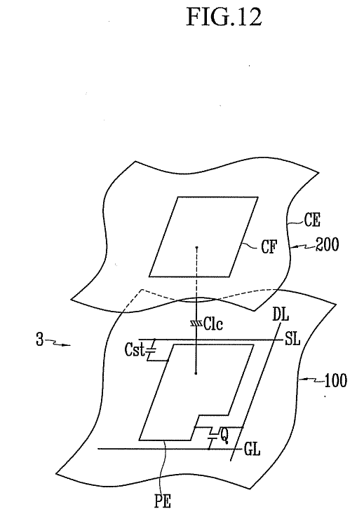

FIG. 12 is an equivalent circuit diagram of one exemplary pixel in an exemplary LCD according to another exemplary embodiment of the present invention.

Referring to FIG. 12, the liquid crystal panel assembly includes lower and upper panels 100 and 200 that face each other, a liquid crystal layer 3 that is interposed between the lower and upper panels 100 and 200, and a pair of polarizers (not shown) that adhere to external surfaces of the display panels 100 and 200.

On the lower panel 100, signal lines that include a plurality of gate lines GL, a plurality of data lines DL, and a plurality of storage electrode lines SL are provided. Each of the pixels has a switching element Q, a liquid crystal capacitor Clc that is connected to the switching element Q, and a storage capacitor Cst that is connected to the switching element Q and the storage electrode line SL.

The switching element Q also corresponds to a three-terminal element such as a TFT that is included in the lower panel 100, and has a control terminal, such as a gate electrode, connected to the gate line GL, an input terminal, such as a source electrode, connected to the data line DL, and an output terminal, such as a drain electrode, connected to the liquid crystal capacitor Clc and the storage capacitor Cst.

The liquid crystal capacitor Clc uses a pixel electrode PE of the lower panel 100 and a common electrode CE of the upper panel 200 as two terminals. The liquid crystal layer 3 that is interposed between the common electrode CE and the pixel electrode PE serves as a dielectric material. The common electrode CE is formed on the entire surface, or substantially the entire surface, of the upper panel 200, and is applied with a common voltage Vcom. The liquid crystal layer 3 has negative dielectric anisotropy, and the liquid crystal molecules of the liquid crystal layer 3 may be aligned such that long axes thereof are perpendicular to the surfaces of the two display panels 100, 200 in the absence of an electric field.

The operation of the LCD shown in FIG. 12 that includes the storage capacitor Cst and the liquid crystal panel assembly is substantially the same as that of the LCD according to the above-described exemplary embodiment, and thus a detailed description thereof will be omitted. However, in the LCD shown in FIG. 12, one pixel PX is not divided into two electrodes, but is constructed as one electrode.

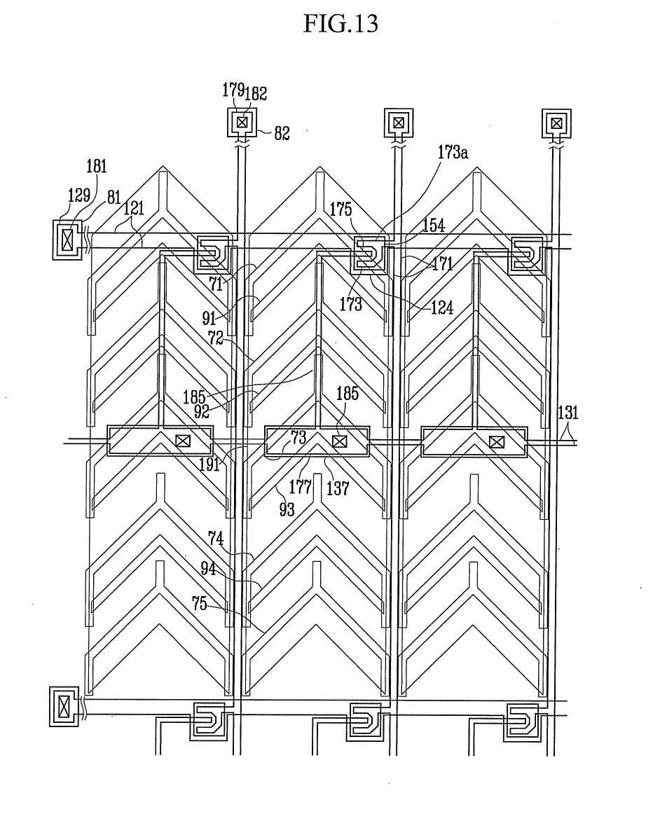

An example of the liquid crystal panel assembly shown in FIG. 12 will now be described with reference to FIG. 13.

FIG. 13 is a layout view of an exemplary liquid crystal panel assembly according to an exemplary embodiment of the present invention.

Referring to FIG. 13, the liquid crystal assembly includes a lower panel 100 and an upper panel 200 that face each other, and a liquid crystal layer 3 that is interposed between the two display panels 100 and 200.

A layered structure of the liquid crystal panel assembly illustrated in FIG. 13 is substantially the same as that of the liquid crystal panel assembly in FIGS. 5 to 7.

The lower panel 100 will now be described. On the insulation substrate (not shown), a plurality of gate conductors that include a plurality of gate lines 121 and a plurality of storage electrode lines 131 are formed. Each of the gate lines 121 has a gate electrode 124 and an end 129, and each of the storage electrode lines 131 has a storage electrode 137. A gate insulating layer (not shown) is formed on the gate conductors 121 and 131 and on the insulation substrate. A plurality of semiconductors 154 are formed on the gate insulating layer, and a plurality of ohmic contacts (not shown) are formed on the plurality of semiconductors 154. Data conductors that include a plurality of data lines 171 and a plurality of drain electrodes 175 are formed on the ohmic contacts and the gate insulating layer. Each data line 171 has a plurality of source electrodes 173 and an end 179, and each drain electrode 175 has a wide end 177. A passivation layer 180 is formed on the data conductors 171 and 175, the exposed portions of the semiconductors 154, and the gate insulating layer, and a plurality of contact holes 181, 182, and 185 are formed in the passivation layer and the gate insulating layer. On the passivation layer, a plurality of pixel electrodes 191 and a plurality of contact assistants 81 and 82 that are connected to the wide ends 177 of the drain electrodes 175 and the ends 121 and 179 of the gate lines 121 and the data lines 171, respectively, are formed. Each pixel electrode 191 is provided with cutouts 91, 92, 93, and 94. An alignment layer (not shown) is formed on the pixel electrodes 191, the contact assistants 81 and 82, and the passivation layer.

The upper panel 200 will now be described. On an insulation substrate, a light blocking member, a plurality of color filters, an overcoat, a common electrode having cutouts 71, 72, 73, 74, and 75, and an alignment film are formed.

In the liquid crystal panel assembly according to the present exemplary embodiment, as compared with the liquid crystal panel assembly shown in FIGS. 5 to 7, the storage electrode 137 expands in a vertical direction in the storage electrode line 131, having a width extending in a direction of the data line 171, such that it is elongated parallel to the gate line 121, having a length extending in a direction of the gate line 121, such that it can be connected to the neighboring pixel electrode 191.

Further, the pixel electrode 191 is not divided into two electrodes, but is constructed as one electrode. Accordingly, the same voltage is applied to all of the pixel electrodes 191.

A variety of characteristics of the liquid crystal panel assembly shown in FIGS. 10 and 11 are applicable to the liquid crystal panel assembly shown in FIGS. 12 and 13.

A method of improving lateral visibility in an LCD is thus made possible using the above-described exemplary embodiments. The method may include forming gate lines in a first direction on a substrate, forming data lines in a second direction on the substrate, and forming at least one pixel electrode per pixel area on the substrate, the at least one pixel electrode having a substantially simple concave hexagon shape formed in an arrow shape with one concavity, the arrow shape pointing in the second direction. Forming the at least one pixel electrode per pixel area may include forming first and second subpixel electrodes per pixel area, each of the first and second subpixel electrodes having a substantially simple concave hexagon shape formed in an arrow shape with one concavity, the arrow shape pointing in the second direction, the second subpixel electrodes nesting within concavities of adjacent first pixel electrodes, and the first subpixel electrodes nesting within concavities of adjacent second subpixel electrodes. Forming the at least one pixel electrode per pixel area may also include forming first and second subpixel electrodes per pixel area and forming an area of the first subpixel electrodes smaller than an area of the second subpixel electrodes, and the method may further include applying a larger voltage via the data lines to the first subpixel electrodes than to the second subpixel electrodes.

According to the present invention, lateral visibility of the LCD may be improved by a simple structure of a pixel, and a pixel region may be easily formed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a substrate; and
pixel electrodes formed on the substrate, each of the pixel electrodes having first and second subpixel electrodes,
wherein each of the first and second subpixel electrodes has at least two parallelogrammic electrode pieces, each of the two parallelogrammic electrode pieces having lengthwise edges and oblique edges adjacent to the lengthwise edges.

2. The liquid crystal display of claim 1, wherein in each of the first and second subpixel electrodes, the lengthwise edges of the at least two electrode pieces contact each other.

3. The liquid crystal display of claim 2, wherein in each of the first and second subpixel electrodes, the oblique edges of the at least two electrode pieces form a right angle so as to be connected to each other.

4. The liquid crystal display of claim 1, wherein a height of the first subpixel electrode is different from a height of the second subpixel electrode.

5. The liquid crystal display of claim 1, wherein the first subpixel electrode and the second subpixel electrode are adjacent to each other in a vertical direction.

6. The liquid crystal display of claim 5, wherein a lengthwise center line of the first subpixel electrode aligns with a lengthwise center line of the second subpixel electrode.

7. The liquid crystal display of claim 1, further comprising:
a common electrode facing the pixel electrodes; and
first inclination direction determining members formed on the common electrode.

8. The liquid crystal display of claim 7, wherein the first inclination direction determining members have a plurality of first cutouts having oblique portions substantially parallel to the oblique edges of the electrode pieces.

9. The liquid crystal display of claim 8, further comprising second inclination direction determining members, each second inclination direction determining member formed in each of the first and second subpixel electrodes.

10. The liquid crystal display of claim 9, wherein the second inclination direction determining members have a plurality of second cutouts having oblique portions substantially parallel to the oblique edges of the electrode pieces.

11. The liquid crystal display of claim 1, wherein a voltage of the first subpixel electrode and a voltage of the second subpixel electrode are different from each other.

12. The liquid crystal display of claim 11, wherein an area of the first subpixel electrode is smaller than an area of the second subpixel electrode, and the voltage of the first subpixel electrode is larger than the voltage of the second subpixel electrode.

13. The liquid crystal display of claim 12, wherein the first subpixel electrode and the second subpixel electrode are supplied with different data voltages originated from a single image information.

14. The liquid crystal display of claim 13, further comprising:
first thin film transistors connected to corresponding first subpixel electrodes;
second thin film transistors connected to corresponding second subpixel electrodes;
first signal lines connected to the first thin film transistors;
second signal lines connected to the second thin film transistors; and
third signal lines connected to the first and second thin film transistors and crossing the first and second signal lines.

15. The liquid crystal display of claim 14, wherein the first and second thin film transistors are turned on according to signals supplied through the first and second signal lines, and transmit signals supplied through the third signal lines.

16. The liquid crystal display of claim 14, wherein the first and second thin film transistors are turned on according to signals supplied through the third signal lines, and transmit signals supplied through the first and second signal lines.

17. The liquid crystal display of claim 14, further comprising
fourth signal lines crossing the pixel electrodes.

18. The liquid crystal display of claim 17, wherein the first and second thin film transistors have first and second drain electrodes overlapping the fourth signal lines.

19. The liquid crystal display of claim 11, wherein the first subpixel electrode and the second subpixel electrode are capacitively coupled to each other.

20. The liquid crystal display of claim 19, further comprising:
thin film transistors connected to corresponding first subpixel electrodes;
first signal lines connected to corresponding thin film transistors; and
second signal lines connected to the thin film transistors and crossing the first signal lines.

21. The liquid crystal display of claim 1, wherein the first and second subpixel electrodes are connected to each other.

22. The liquid crystal display of claim 1, wherein each of the first and second subpixel electrodes has a substantially simple concave hexagon shape formed in an arrow shape with one concavity.

23. The liquid crystal display of claim 22, wherein a convex portion of the first subpixel electrodes is nested within the concavity of adjacent second subpixel electrodes, and a convex portion of the second subpixel electrodes is nested within the concavity of adjacent first subpixel electrodes.

24. A liquid crystal display comprising:
a substrate; and
pixel electrodes formed on the substrate;
wherein each of the pixel electrodes has at least two parallelogrammic electrode pieces, each of the parallelogrammic electrode pieces having lengthwise edges and oblique edges adjacent to the lengthwise edges.

25. The liquid crystal display of claim 24, wherein the lengthwise edges of the at least two electrode pieces contact each other.

26. The liquid crystal display of claim 24, wherein the oblique edges of the at least two electrode pieces form a right angle so as to be connected to each other.

27. The liquid crystal display of claim 24, further comprising:
thin film transistors connected to the pixel electrodes;
first signal lines connected to the thin film transistors; and
second signal lines connected to the thin film transistors and crossing the first signal lines.

28. The liquid crystal display of claim 24, wherein each of the pixel electrodes has a substantially simple concave hexagon shape formed in an arrow shape with one concavity.

29. A method of improving lateral visibility in a liquid crystal display, the method comprising:
forming gate lines in a first direction on a substrate;
forming data lines in a second direction on the substrate; and,
forming at least one pixel electrode per pixel area on the substrate, the at least one pixel electrode having a substantially simple concave hexagon shape formed in an arrow shape with one concavity, the arrow shape pointing in the second direction.

30. The method of claim 29, wherein forming at least one pixel electrode per pixel area includes forming first and second subpixel electrodes per pixel area, each of the first and second subpixel electrodes having a substantially simple concave hexagon shape formed in an arrow shape with one concavity, the arrow shape pointing in the second direction, the second subpixel electrodes nesting within concavities of adjacent first pixel electrodes, and the first subpixel electrodes nesting within concavities of adjacent second subpixel electrodes.

31. The method of claim 29, wherein forming at least one pixel electrode per pixel area includes forming first and second subpixel electrodes per pixel area and forming an area of the first subpixel electrodes smaller than an area of the second subpixel electrodes, the method further comprising applying a larger voltage via the data lines to the first subpixel electrodes than to the second subpixel electrodes.
